(19) United States
(12) Patent Application Publication
(10) Pub. No.: US 2008/0181146 A1
(43) Pub. Date: Jul. 31, 2008

(54) WiFi antenna system and method of operation

(75) Inventor: Minh Doan, King City (CA)

Correspondence Address: SAND & SEBOLT, AEGIS TOWER, SUITE 1100, 4940 MUNSON STREET, NW, CANTON, OH, 44718-3615, US

(73) Assignee: AIRESURF NETWORKS HOLDINGS INC., Toronto (CA)

(21) Appl. No.: 11/700,793

(22) Filed: Jan. 31, 2007

(51) Int. Cl. H04B 7/00

(52) U.S. Cl. 370/310

(57) ABSTRACT

A WiFi antenna system includes a WiFi amplifier having a reception antenna and a separate transmission antenna for respectively receiving from and transmitting to WiFi devices such as laptop computers and the like. A logic circuit controls transmission and reception of signals via the antennas. Preferably, a splitter-combiner splits signals from a local area network (LAN) and a signal level comparator determines whether the LAN signals are transmission signals which should be transmitted via the transmission antenna. If so, the logic circuit controls the power levels of the two antennas to that effect. Preferably, the transmission antenna is normally at a standby power level while the reception antenna is at a high gain operational power level. If a signal is to be transmitted via the transmission antenna, the logic circuit increases the transmission power level to a maximum allowable and decreases the reception power level to a standby level.

### BACKGROUND OF THE INVENTION

1. Technical Field

The present invention relates generally to antenna systems. More particularly, the invention relates to a WiFi antenna system and to the WiFi amplifier thereof. Specifically, the invention relates to a WiFi amplifier having separate reception and transmission antennas.

2. Background Information

WiFi or “wireless fidelity” describes the wireless networks that adhere to the specifications developed by the Institute of Electrical and Electronic Engineers (IEEE) for wireless local area networks (LAN). A WiFi device is certified to be interoperable with other certified devices using the 802.11 specification of the IEEE. These devices allow over-the-air interfaces between computers and devices in order to create a wireless network for facilitating data transfer. This typically ends up with a connection to a LAN. In this regard, WiFi is a wireless link to the typical computer network and the internet.

Operating frequencies range within the WiFi family, with 2.4 GHz being the target for this WiFi amplifier. Multiple protocols exist at this frequency and differ by transmit bandwidth.

Currently, WiFi regulation is not too onerous. The 802.11 protocol resolves many interference problems and addresses human safety by requiring a limit on the power at the 2.4 GHz band. Presently, it is common for value added resellers (VARs) to “juice up” clients' systems without greatly affecting others, but as systems expand, tighter regulation will follow.

Because the small transmission (TX) power from the transmitters of laptops and similar devices are generally the weakest link in WiFi systems, it is of key importance to be able to increase the station receiver sensitivity. The best way to accomplish this is utilizing a high gain antenna that can increase the signal strength to the receiver by 10 times or more. However, with single antenna systems, the high gain antenna would also boost the transmit power by 10 times, which would cause the signal to exceed the legal limit of 1 Watt Effective Isotropic Radiated Power (EIRP).

### BRIEF SUMMARY OF THE INVENTION

The present invention provides an apparatus comprising: a WiFi amplifier; a transmission (TX) antenna connector on the amplifier adapted to connect to a TX antenna for transmitting radio frequency (RF) signals to a WiFi device; and a separate reception (RX) antenna connector on the amplifier adapted to connect to a separate RX antenna for receiving RF signals from a WiFi device.

The present invention further provides a method comprising the steps of: transmitting RF signals at a first gain with a TX antenna of a WiFi amplifier; and receiving RF signals at a second gain different than the first gain with a separate RX antenna of the WiFi amplifier.

### BRIEF DESCRIPTION OF THE SEVERAL VIEWS OF THE DRAWINGS

FIG. 1 is a diagrammatic view of the WiFi antenna system of the present invention.

FIG. 2 is a diagrammatic view of the WiFi amplifier of the present invention.

Similar numbers refer to similar parts throughout the drawings.

### DETAILED DESCRIPTION OF THE INVENTION

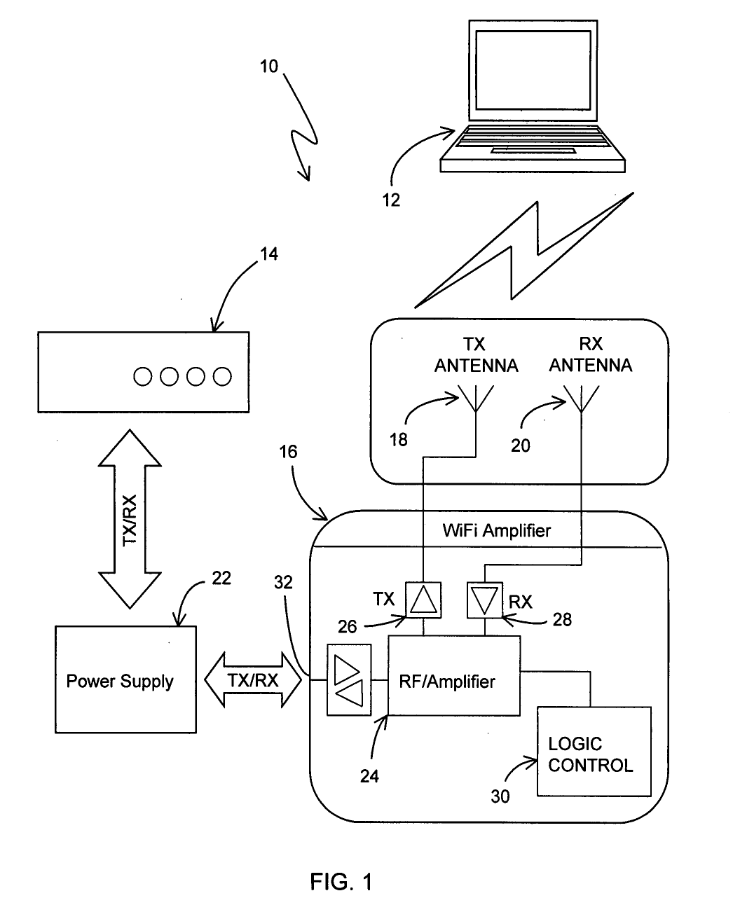

The WiFi antenna system of the present invention is indicated generally at 10 in FIG. 1. System 10 is used for transmitting and receiving radio frequency (RF) signals between a WiFi device 12 and a local area network 14 (LAN). WiFi device 12 is a device having a transmitter and receiver for communicating within the WiFi parameters. Device 12 is typically a laptop computer, a palmtop computer, a pocket computer or any other personal digital assistant (PDA) having a WiFi transmitter and receiver. LAN 14 includes an access point, a router or a hub with which system 10 communicates to access computer networks and/or the internet.

In accordance with the invention, system 10 includes a WiFi amplifier 16 with a transmit or transmission (TX) antenna 18 and a separate receive or reception (RX) antenna 20. System 10 further includes a DC power supply 22. WiFi amplifier 16 comprises an enclosure formed of a material such as aluminum which provides RF shielding and protection against weather. Amplifier 16 may be mounted wherever desired, such as a wall, ceiling, floor or otherwise. WiFi amplifier 16 includes an RF amplifier 24, a TX antenna connector 26 and an RX antenna connector 28 to which antennas 18 and 20 are respectively removably connected to provide electrical communication between the antennas and RF amplifier 24. WiFi amplifier 16 further comprises a logic control 30 having a logic circuit for controlling the power levels of the TX and RX connectors and antennas. Control 30 may include a CPU and generally controls the TX and RX signals along the respective pathways between WiFi device 12 and LAN 14 as will be further detailed below.

Depending on the desired coverage and the specific characteristics of the location at which system 10 is to be used, various types of antennas may be used. TX antenna 18 may range from an omni directional no gain TX antenna to a high gain directional TX antenna of various styles, such as plate, yagi or other suitable antennas. RX antenna 20 is typically a high gain directional type antenna suited for good reception of WiFi transmissions from device 12. WiFi amplifier 16 also includes a LAN data or signal access port 32 in electrical communication with RF amplifier 24 which may be connected to LAN 14 typically by an electrical cord which plugs into a standard access point, to allow the transmission and reception of TX and RX signals between WiFi amplifier 16 and LAN 14.

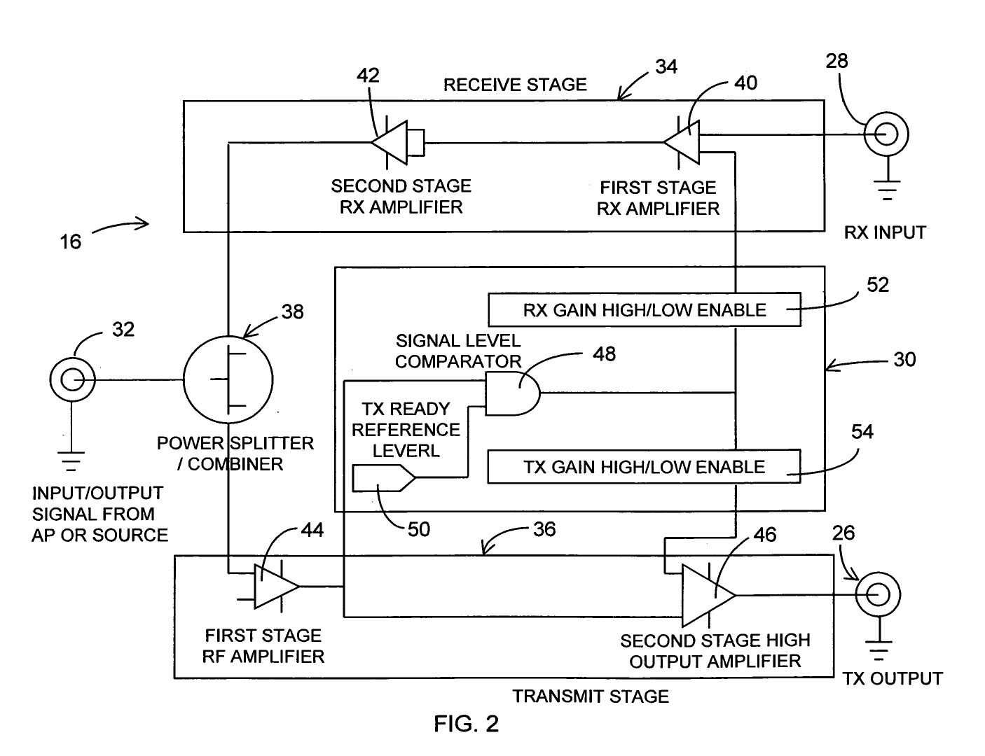

In accordance with a feature of the invention and with reference to FIG. 2, WiFi amplifier 16 comprises a receive or reception stage or pathway 34, a transmit or transmission stage or pathway 36, a power splitter-combiner 38 in electrical communication with one another and logic control 30. Reception pathway 34 includes a first stage RX amplifier 40 in electrical communication with RX connector 28 and a second stage RX amplifier 42 in electrical communication with first amplifier 40 and splitter-combiner 38. Transmission pathway 36 likewise includes a first stage RF amplifier 44 in electrical communication with splitter-combiner 38 and a second stage high output RF amplifier 46 in electrical communication with amplifier 44 and TX connector 26.

In accordance with the invention, logic control 30 includes a signal level comparator 48 for comparing the power level of an input signal from LAN 14 via port 32 with a TX ready reference level or threshold power level 50 stored in the memory of control 30. The logic circuit of control 30 further includes a gain control for controlling the RX gain and TX gain of pathways 34 and 36 depending on whether comparator 48 determines that the input signal exceeds threshold level 50 or not. FIG. 2 shows this gain control as RX gain high/low enable 52 and TX gain high/low enable 54.

The operation of system is now described. In the preferred embodiment, system 10 is configured to operate RX antenna 20 at a relatively high gain and TX antenna 18 at a relatively low gain except when transmissions via TX antenna 18 are required. The relatively high gain of RX antenna 20 allows for good reception of RF transmissions from various WiFi devices 12. Preferably, control 30 sets the power level of TX antenna connector 26 and TX antenna 18 at a standby power level so that any RF signals on transmit pathway 36 either will not be transmitted via TX antenna 18 or will be transmitted at such a minimal power level as to be insignificant and not suitable for use by a WiFi device 12. Signal splitter-combiner 38 thus receives input from LAN 14 via port 32 and splits the signals while also combining or recombining RX input signals from reception pathway 34 to be sent to LAN 14 via access port 32. The split signal from splitter-combiner 38 is sent via first stage amplifier 44 to comparator 48, which determines whether or not a given signal exceeds threshold level 50. If not, logic control 30 maintains the TX gain or power level at the relatively lower and preferably standby level to effectively prevent transmission via TX antenna 18. However, if the signal exceeds threshold level 50, logic control 30 instantaneously alters the power levels within the reception and transmission pathways 34 and 36, more particularly increasing the power level to TX antenna 18 to an operational power level which is preferably substantially the maximum allowable power, which equates to 1 watt EIRP, while simultaneously decreasing the power to RX antenna 20 most preferably to a standby level until the transmission of the transmit signal is achieved. Once the transmission signal or pathway from LAN 14 is transmitted via TX antenna 18, control 30 instantly switches the power levels back to their original state, thus increasing the power level to RX antenna 20 to its maximum or other operational power level while reducing the power level to TX antenna 18 to the standby level.

Thus, in the preferred embodiment, WiFi amplifier 16 effectively alternates between a receive-only state and a transmit-only state. WiFi amplifier 16 thus is able to transmit at the maximum allowable power through the dedicated TX antenna 18 while receiving signals via RX antenna 20 at a different and typically higher gain than that of TX antenna 18. In other words, WiFi amplifier 16 allows for a high gain directional receive capability while maintaining maximum transmit power and orientation. Amplifier 16 also allows for customized antenna selection and site setup based on unique site conditions while using only one amplifier.

It is noted that various changes may be made within the scope of the present invention. One such change is the use of a high speed switch in place of splitter-combiner 38. While the latter is preferred, the designation of splitter-combiner 38 also represents such a switch, which allows for the switching of signals between reception pathway 34 and transmission pathway 36. If such a switch is used, it normally keeps the RX pathway or circuit closed to allow RX signals to travel from RX connector 28 to LAN 14 via port 32 unless comparator 48 senses a signal in excess of threshold level 50, whereupon control 30 operates the switch to open the RX pathway and close the TX pathway or circuit to allow the signal to be transmitted via TX antenna 18. When a switch is used in this manner, comparator 48 is in electrical communication with port 32 between port 32 and the switch.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus comprising:
a WiFi amplifier;
a transmission (TX) antenna connector on the amplifier adapted to connect to a TX antenna for transmitting radio frequency (RF) signals to a WiFi device; and
a separate reception (RX) antenna connector on the amplifier adapted to connect to a separate RX antenna for receiving RF signals from a WiFi device.

2. The apparatus of claim 1 further comprising a logic circuit in electrical communication with the TX and RX antenna connectors and programmed for controlling respective power levels thereof.

3. The apparatus of claim 2 wherein the logic circuit is programmed for increasing the power level to the TX antenna connector while reducing the power level to the RX antenna connector.

4. The apparatus of claim 3 wherein the logic circuit is programmed for reducing the power level to the TX antenna connector while increasing power to the RX antenna connector.

5. The apparatus of claim 2 wherein the logic circuit is programmed to set power to the TX antenna connector at a standby power level.

6. The apparatus of claim 5 wherein the logic circuit is programmed set the TX antenna connector at a standby power level while the RX antenna connector is at an operational power level.

7. The apparatus of claim 6 wherein the logic circuit is programmed set the RX antenna connector at a standby power level while the TX antenna connector is at an operational power level.

8. The apparatus of claim 5 wherein the logic circuit is programmed to maintain power to the TX antenna connector at a standby power level unless a TX signal is received from a local area network (LAN).

9. The apparatus of claim 1 further comprising a logic circuit in electrical communication with the TX and RX antenna connectors and programmed for controlling TX and RX signals to and from the antenna connectors.

10. The apparatus of claim 9 further comprising a local area network (LAN) signal access port in electrical communication with the TX and RX connectors and adapted for sending output signals to and receiving input signals from a LAN.

11. The apparatus of claim 10 wherein the logic circuit is programmed for transmitting via the TX antenna connector only when input signals received via the LAN signal access port are TX signals.

12. The apparatus of claim 9 wherein the logic circuit is programmed for switching between receiving RX signals via the RX antenna connector and transmitting TX signals via the TX antenna connector.

13. The apparatus of claim 1 further comprising a local area network (LAN) signal access port in electrical communication with the TX and RX connectors and adapted for sending output signals to and receiving input signals from a LAN.

14. The apparatus of claim 13 further comprising a signal splitter-combiner in electrical communication with the access port and the TX and RX connectors.

15. The apparatus of claim 13 further comprising a switch for switching between a TX electric pathway between the access port and the TX antenna connector and an RX electric pathway between the access port and the RX antenna connector.

16. The apparatus of claim 13 further comprising a signal level comparator in electrical communication with the access port for comparing a power level of a signal from the access port with a predetermined TX signal threshold power level; and wherein the logic circuit is programmed to send the signal to the TX antenna connector if the signal exceeds the threshold power level.

17. The apparatus of claim 16 wherein the logic circuit is programmed to increase the power level to the TX antenna connector and reduce the power level to the RX antenna connector if the signal exceeds the threshold power level.

18. The apparatus of claim 17 wherein the logic circuit is programmed to increase the power level to the TX antenna connector from a standby power level to an operational power level and reduce the power level to the RX antenna connector from an operational power level to a standby power level if the signal exceeds the threshold power level.

19. The apparatus of claim 1 further comprising a TX antenna connected to the TX antenna connector; and a separate RX antenna connected to the RX antenna connector.

20. A method comprising the steps of:
transmitting RF signals at a first gain with a TX antenna of a WiFi amplifier; and
receiving RF signals at a second gain different than the first gain with a separate RX antenna of the WiFi amplifier.
